(19) United States
(12) Patent Application Publication
(10) Pub. No.: US 2024/0070659 A1
(43) Pub. Date: Feb. 29, 2024

(54) SYSTEMS AND METHODS FOR FACILITATING BLOCKCHAIN OPERATIONS ACROSS MULTIPLE BLOCKCHAIN NETWORKS USING A DECENTRALIZED EXCHANGE

(71) Applicant: Coinbase, Inc., Oakland, CA (US)

(72) Inventors: Kenzan BOO, Oakland, CA (US); Kim BUI, Oakland, CA (US); Mansi PRAKASH, Oakland, CA (US); Steve GODLEWSKI, Oakland, CA (US)

(73) Assignee: Coinbase, Inc., Oakland, CA (US)

(21) Appl. No.: 17/823,123

(22) Filed: Aug. 30, 2022

(51) Int. Cl. G06Q 20/38; G06Q 20/36

(52) U.S. Cl. CPC G06Q 20/389; G06Q 20/36

(57) ABSTRACT

Methods and systems use a dynamic gas range approach for facilitating blockchain operations across multiple blockchain networks using a decentralized exchange. Use of the multi-modal dynamic gas range process allows for the system to separate the data collection operation (e.g., analyzing data across many layers, features, front-end systems, back-end systems, libraries, and/or channels of multiple blockchain networks) and the dynamic gas range estimation operation. By doing so, the system first allows static blockchain operation characteristics to be verified, reducing uncertainty related to the cost of the blockchain operation (e.g., due to impermanent loss and continually changing network congestion). For example, the system may perform verifications and validations on data in a piecemeal manner such that errors and/or network conditions affecting the blockchain operation may be detected prior to the blockchain operation being confirmed. Thus, the system may generate warnings and/or recommendations to mediate errors before a blockchain operation is confirmed.

### BACKGROUND

In recent years, the use of blockchains and blockchain technology has exponentially increased. Blockchains comprise a list of records, called “blocks,” that are “chained” together using cryptography. Each block may comprise data that is computed using a one-way function (e.g., a function that is practically impossible to invert or reverse-compute) of a previous block, a timestamp (e.g., indicating a creation and/or modification time), and additional data (e.g., transactional or operational data related to blockchain operations).

While publicity for blockchains and blockchain technology has been concentrated on its use for cryptocurrencies and smart contracts, blockchains and blockchain technology may be applicable to numerous technological avenues. A common theme of the technological avenues is the manner in which blockchains and blockchain technology are decentralized such that facilitation, management, and/or verification of blockchain-based operations is governed or administered not by any one authority but instead by a community of users. The blockchain may therefore remain distributed (e.g., on a network of computers that communicate and coordinate their actions by passing messages to one another), and in many cases public, through a digital ledger, which records the series of blocks forming the chain. Notably, because each block depends on a preceding block, edits to existing blocks in the chain may not be made without affecting subsequent blocks.

Furthermore, updates to the blockchain (e.g., the addition of new blocks) may include incentivization systems that reward community members for the generation of the updates while also ensuring a consensus by the community. By doing so, the proliferation of the blockchain may proceed indefinitely.

### SUMMARY

Methods and systems are described herein for novel uses and/or improvements to blockchains and blockchain technology. As one example, methods and systems are described herein for novel uses and/or improvements to blockchains and blockchain technology that use a proof-of-stake consensus mechanism.

Proof-of-stake is a type of consensus mechanism that may be used by a blockchain network to achieve distributed consensus and thus avoid a centralized authority. The benefits of proof-of-stake (e.g., as compared to a proof-of-work consensus mechanism) includes better energy efficiency and lower barriers of entry, which may lead to a larger overall node network (as mining blocks is both less costly due to energy efficiency and does not require specialized hardware). For example, unlike a proof-of-work consensus mechanism, the blockchain network does not rely on mining new blocks based on exercising significant amounts of computational power. Instead, validators for the proof-of-stake consensus mechanism are chosen at random based on meeting a threshold staking requirement. Validators then receive rewards for proposing new blocks and for attesting to ones that they have viewed. In contrast, validators may lose their stake for attesting to incorrect or malicious blocks.

Within this context, conventional proof-of-stake consensus mechanisms rely on a first-price auction as main gas fee calculation methodology. For example, in first-price auctions, users may set an amount of gas that the user will pay to have their blockchain operation processed. In such cases, the users with the highest amounts will have their blockchain operations processed first (as the validators chose the blockchain operations with the highest gas fee, which in turn became their reward). In contrast to this, methods and systems described herein relate to a new gas fee calculation (e.g., based on a new blockchain operation type) that may allot a dynamic “base fee,” which is burned, and an additional fee that is allocated to the validator. While the new gas fee calculation may make the gas fee calculation more transparent and may allow for gas fees to be better estimated, implementation of the new gas fee calculation presents several technical challenges. For example, Ethereum Improvement Proposal (EIP) 1559 will introduce a new blockchain operation type (e.g., a transaction based on a new EIP-2718 transaction envelope type). The EIP-2718 transaction envelope type allows for the use of transaction pricing mechanism that includes fixed-per-block portion of the network fee (e.g., the base fee) that is burned and dynamically expands/contracts block sizes to deal with transient congestion as opposed to the first-price action.

While the EIP-1599 update aims to deal with transient congestion on the Ethereum network, the EIP-1599 presents a technical challenge to other blockchain networks, in particular those that aim to access the Ethereum network via a decentralized exchange. For example, a decentralized exchange (DEX) is a peer-to-peer marketplace where transactions occur directly between users that exclusively trade cryptocurrency tokens for other cryptocurrency tokens. The EIP-1599 update presents a challenge for DEXs in that any trade now requires information of multiple dynamic blockchain operation characteristics (e.g., based on current network congestion on a respective blockchain network). These dynamic blockchain operation characteristics (e.g., network fees) are inherently unpredictable. Despite the unpredictability, the DEX (or more particularly, the user interface for a DEX application) needs to provide a reasonable estimate because blockchain operations are by their nature immutable and irreversible. That is, once a blockchain operation is committed to the blockchain network, the blockchain operation is final. For example, while operations on a centralized exchange are recorded on that exchange's internal database, DEX operations are settled directly on the blockchain.

In additional to the sheer unpredictability of dynamic blockchain operation characteristics for respective blockchain networks, DEXs and blockchain operations conducted through a DEX must deal with a novel technical problem associated specifically with DEX and their underlying functionality. Specifically, a DEX must account for “impermanent loss,” which can result from pairing a more volatile cryptocurrency with a less volatile one in a liquidity pool. For example, unlike conventional exchanges, a DEX may simply be a set of smart contracts. The smart contracts may establish the prices of various cryptocurrencies against each algorithmically and use “liquidity pools”—in which users lock funds in exchange for interest-like rewards—to facilitate trades. As there is no central authority, the risk of impermanent loss, as well as other risks (e.g., risk due to the vast array of unvetted tokens being used for fraud and/or other scams), poses a unique technical challenge to DEXs.

One solution to compensating for the finality of blockchain operations that may have inherent unpredictability in the dynamic blockchain operation characteristics is to provide an initial estimated fee, as well as a maximum fee. For example, the estimated fee may be based on static characteristics of a given blockchain operation (e.g., a transaction amount) and a maximum fee for any given state of the blockchain network (e.g., a state at a maximum congestion). While the maximum fee ensures that users may anticipate any fees in excess of the estimate, the use of static estimates in a dynamic environment (e.g., an environment where the characteristics of the blockchain network are continually changing) leads to a reduced user experience as the estimates are frequently incorrect and do not inform users of a true cost. Furthermore, as the estimate must be based on multiple dynamic blockchain operation characteristics for respective blockchain networks, such an approach only compounds the uncertainty and further reduces the user experience.

In contrast, the methods and systems described herein use a dynamic approach that provides a dynamic gas range estimate. For example, the dynamic gas range estimate accounts for the uncertainty in the continually changing blockchain network characteristics for the multiple blockchain networks. However, creating a dynamic range of gas fee estimates creates a novel problem in how to estimate the dynamic gas range estimate. For example, determining a dynamic gas range estimate based on the blockchain network involves analyzing data across many layers, features, front-end systems, back-end systems, libraries, and/or channels. Additionally, determining the dynamic gas range estimate based on a given blockchain operation involves retrieving specific operation details for the blockchain operation across multiple blockchain networks.

In view of the variables, the methods and systems use a dynamic gas range approach for facilitating blockchain operations across multiple blockchain networks using a decentralized exchange. The use of the multi-modal dynamic gas range process allows for the system to separate the data collection operation (e.g., analyzing data across many layers, features, front-end systems, back-end systems, libraries, and/or channels of multiple blockchain networks) and the dynamic gas range estimation operation. By doing so, the system first allows static blockchain operation characteristics to be verified thus reducing uncertainty related to the cost of the blockchain operation (e.g., due to impermanent loss and continually changing network congestion). For example, the system may perform verifications and validations on data in a piecemeal manner such that errors and/or network conditions affecting the blockchain operation may be detected prior to the blockchain operation being confirmed. Thus, the system may generate warnings and/or recommendations to mediate errors before a blockchain operation is confirmed.

Having mitigated the uncertainty, the system now transitions to the dynamic gas range estimation operation by determining lower and upper bounds for the respective blockchain operations on the multiple blockchain networks. By using the lower and upper bounds of the multiple blockchain networks and then summing these bounds to generate a dynamic gas range estimation (e.g., as opposed to estimating a maximum fee and applying a confidence interval), the system dynamic gas range estimation that is more immune to large deviations in network congestion, which may plague the new tokens and blockchain networks serviced by the DEX.

In some aspects, systems and methods for facilitating blockchain operations across multiple blockchain networks using decentralized exchanges are described. For example, the system may receive, at a first user device, a first user request to execute a blockchain operation, across a first blockchain network and a second blockchain network, in a decentralized exchange using a first cryptography-based, storage application. The system may, in response to receiving the first user request, determine a first static blockchain operation characteristic for the blockchain operation, wherein the first static blockchain operation characteristic is based on a first user input. The system may retrieve first network congestion data from the first blockchain network. The system may determine a first dynamic blockchain operation characteristic based on the first network congestion data. The system may retrieve second network congestion data from the second blockchain network. The system may determine a second dynamic blockchain operation characteristic based on the second network congestion data. The system may determine a first threshold criterion based on the first dynamic blockchain operation characteristic and the second dynamic blockchain operation characteristic. The system may compare the first static blockchain operation characteristic to the first threshold criterion to determine whether the first static blockchain operation characteristic equals or exceeds the first threshold criterion. The system may, in response to determining that the first static blockchain operation characteristic does not equal or exceed the first threshold criterion, generate for display, in a user interface at the first user device, a first recommendation to modify the first static blockchain operation characteristic.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIGS. 1A-C show illustrative user interfaces related to blockchain operations, in accordance with one or more embodiments.

FIG. 2 shows an illustrative diagram for conducting blockchain operations, in accordance with one or more embodiments.

FIG. 3 shows an illustrative diagram for a decentralized application, in accordance with one or more embodiments.

FIG. 4 shows an illustrative diagram for conducting operations in a decentralized application using blockchain operations, in accordance with one or more embodiments.

FIG. 5 shows an illustrative diagram for a blockchain indexer, in accordance with one or more embodiments.

FIG. 6 shows a flowchart of the steps involved in processing blockchain operations featuring a plurality of blockchain operation types, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

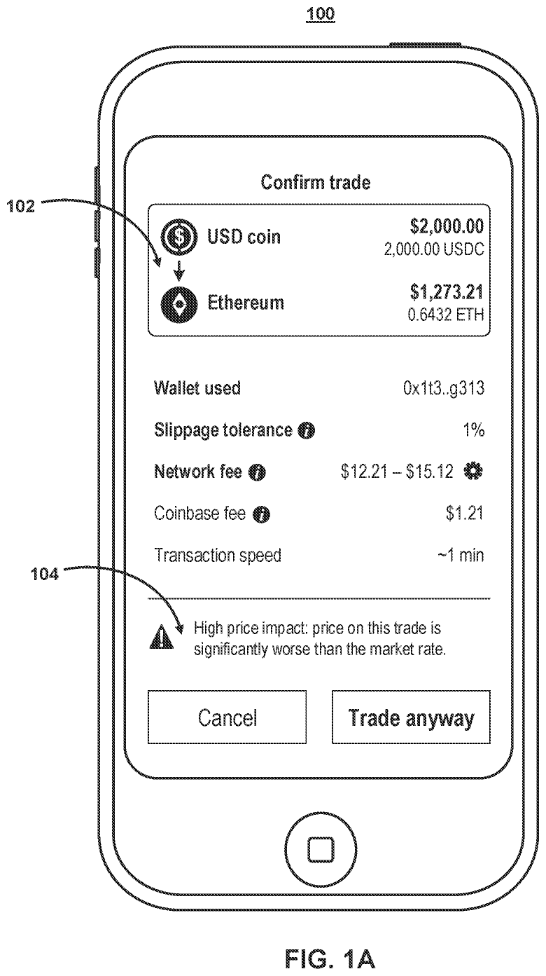

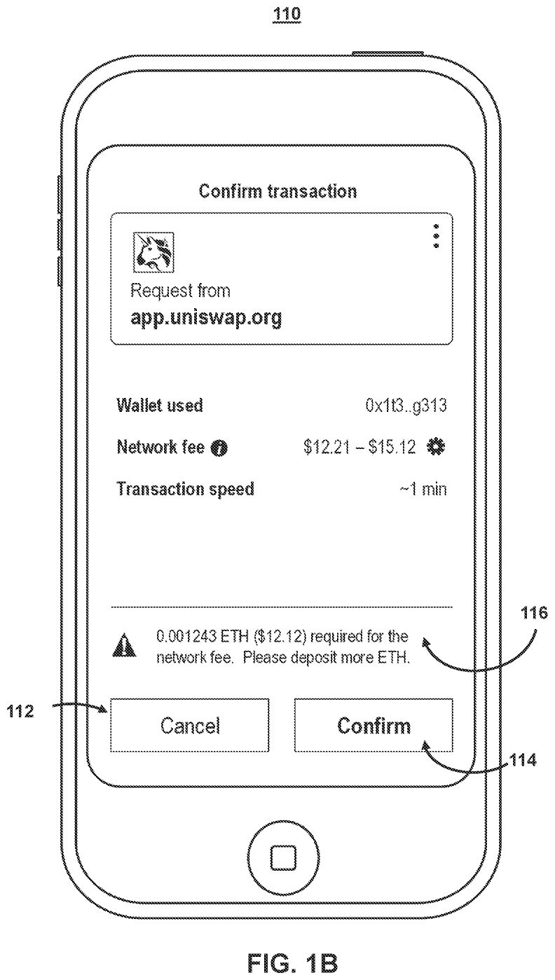

FIGS. 1A-C show illustrative user interfaces related to blockchain operations, in accordance with one or more embodiments. For example, FIG. 1A shows user interface 100, which may comprise a decentralized application browser used for conducting blockchain operations linked to a cryptography-based, storage application. For example, the decentralized application browser may receive user requests for performing a plurality of blockchain operations across a computer network. In some embodiments, an application programming interface (API) implemented on a user device may receive a user request (e.g., from the decentralized application browser) to perform the blockchain operation. As referred to herein, a cryptography-based digital repository or “a cryptography-based, storage application” may refer to a digital wallet. A digital wallet may comprise a software-based system that securely (and typically in an encrypted format) stores users' confidential information, personal information, payment information, and/or passwords for numerous payment methods and websites. By using a digital wallet, users can complete communications, purchases, and/or other blockchain operations easily and securely without risking the information becoming public or subject to a cyberattack. In some embodiments, user interface 100 may illustrate an open connection between a client (mobile or extension) and a decentralized application.

As shown in FIG. 1A, user interface 100 is currently displaying a pending blockchain operation (e.g., blockchain operation 102) for a decentralized exchange. For example, as shown in user interface 100, the blockchain operation comprises exchanging one blockchain network's cryptocurrency (e.g., USD coin) for another blockchain network's cryptocurrency (e.g., Ethereum). As shown in FIG. 1A, the system may bifurcate the data collection operation (e.g., analyzing data across many layers, features, front-end systems, back-end systems, libraries, and/or channels of multiple blockchain networks) from the generation of a dynamic gas range estimation. By doing so, the system first allows static blockchain operation characteristics to be verified thus reducing uncertainty related to the cost of the blockchain operation (e.g., due to impermanent loss and/or continually changing network congestion). For example, the system may perform verifications and validations on data in a piecemeal manner such that errors and/or network conditions affecting the blockchain operation may be detected prior to the blockchain operation being confirmed. Thus, the system may generate warnings and/or recommendations to mediate errors before a blockchain operation is confirmed.

As such the system may detect the network congestion for each portion of a blockchain operation. For example, a blockchain operation may comprise multiple portions (e.g., transactions between different wallets, transactions using different cryptocurrencies, transactions to generate information about a given network, etc.).

For example, some blockchain operations may occur across multiple blockchain networks (e.g., different blockchain protocols, mainchains and sidechains, etc.) and/or be subject to fees (e.g., gas fees) for conducting the blockchain operation on the respective networks.

Other blockchain operations may occur on a single blockchain network. Nonetheless, blockchain operations occurring on a single blockchain network may also include fees related to different portions of the blockchain operation. For example, a blockchain operation that uses a decentralized exchange may include fees that are attributed to the use of the decentralized exchange (e.g., fees split between liquidity providers, protocol fees, etc.). In some embodiments, the transactions fees added by a decentralized exchange and/or split between the liquidity providers may dynamically vary based on current network conditions. For example, a transaction fee may depend on the difference between an internal price oracle and an actual price of an asset.

In both cases, a single blockchain operation may comprise multiple portions and each portion may correspond to a fee (e.g., network fee, transaction fee, etc.). While the source of the fee may vary, these fees may be collectively described as network congestion fees and represented as “network congestion data.”

As shown in FIGS. 1A-C, the system may determine network congestion data for a proposed blockchain operation and generate a recommendation based on the network congestion data. For example, as shown in FIG. 1, the system has determined that current network conditions are unfavorable and has thus generated recommendation 104, which offers the user the option to cancel blockchain operation 102. For example, the system may verify that a static blockchain operation characteristic (e.g., max fee set by a user) meets threshold criteria (e.g., a composite network fee), which the threshold criteria is based on the respective states of the blockchain networks involved in the blockchain operation. For example, a network fee may represent one type of network congestion data.

As referred to herein, a “base fee” or “network fee” refers to an amount of cryptocurrency (or other digital asset) that the blockchain burns in order to process a blockchain operation on the blockchain. For example, a base fee may be a minimum amount fee per gas unit needed to include a new blockchain operation in a block. Before EIP-1559, a blockchain network could not enforce a base fee and all miner fees went to the miner. However, with EIP-1559, most fees are burned and the miner is typically left with a very small remainder. The base fee is used to reach an equilibrium with market demand. By doing so, the system may provide a mechanism that is deflationary for ETH (ether) and ensures miners cannot opt into non-ETH compensation for blockchain operations (e.g., “gasless transactions”).

FIG. 1A includes blockchain operation 102 (e.g., a pending blockchain operation). As referred to herein, “blockchain operations” may comprise any operations, including and/or related to blockchains and blockchain technology. For example, blockchain operations may include conducting transactions, querying a distributed ledger, generating additional blocks for a blockchain, transmitting communications-related nonfungible tokens, performing encryption/decryption, exchanging public/private keys, and/or other operations related to blockchains and blockchain technology. In some embodiments, a blockchain operation may comprise the creation, modification, detection, and/or execution of a smart contract or program stored on a blockchain. For example, a smart contract may comprise a program stored on a blockchain that is executed (e.g., automatically, without any intermediary's involvement or time loss) when one or more predetermined conditions are met. In some embodiments, a blockchain operation may comprise the creation, modification, exchange, and/or review of a token (e.g., a digital asset-specific blockchain), including a nonfungible token. A nonfungible token may comprise a token that is associated with a good, a service, a smart contract, and/or other content that may be verified by, and stored using, blockchain technology. The blockchain operation may comprise a blockchain operation for a decentralized exchange. In such a decentralized exchange blockchain operation, the system may facilitate a blockchain operation that exchanges one cryptocurrency for another.

In some embodiments, blockchain operations may also comprise actions related to mechanisms that facilitate other blockchain operations (e.g., actions related to metering activities for blockchain operations on a given blockchain network). For example, Ethereum, which is an open-source, globally decentralized computing infrastructure that executes smart contracts, uses a blockchain to synchronize and store the system's state changes. Ethereum uses a network-specific cryptocurrency called ether to meter and constrain execution resource costs. The metering mechanism is referred to as “gas.” As the system executes a smart contract, the system accounts for every blockchain operation (e.g., computation, data access, transaction, etc.). Each blockchain operation has a predetermined cost in units of gas (e.g., as determined based on a predefined set of rules for the system). When a blockchain operation triggers the execution of a smart contract, the blockchain operation may include an amount of gas that sets the upper limit of what can be consumed in running the smart contract. The system may terminate execution of the smart contract if the amount of gas consumed by computation exceeds the gas available in the blockchain operation. For example, in Ethereum, gas comprises a mechanism for allowing Turing-complete computation, while limiting the resources that any smart contract and/or blockchain operation may consume.

In some embodiments, gas may be obtained as part of a blockchain operation (e.g., a purchase) using a network-specific cryptocurrency (e.g., ether in the case of Ethereum). The system may require gas (or the amount of the network-specific cryptocurrency corresponding to the required amount of gas) to be transmitted with the blockchain operation as an earmark to the blockchain operation. For example, the required amount of gas may represent one type of network congestion data. In some embodiments, gas that is earmarked for a blockchain operation may be refunded back to the originator of the blockchain operation if, after the computation is executed, an amount remains unused.

For example, before EIP-1559, each blockchain operation (e.g., on the Ethereum network) had a GasPrice set on the blockchain operation. In some blockchain standards, blockchain nodes picked the highest GasPrice transactions to include in the next block. The entire GasPrice was paid directly to the miner, in which GasPaid=GasPrice*GasLimit.

For a legacy blockchain operation on EIP-1559 enabled blockchain (e.g., using a first-price auction), a base fee is required to be included in a block, which is burned by the blockchain network. The system then provides the remainder that is not burned to miners. For EIP-1559 blockchain operations, each blockchain operation includes a MaxFeePerGas and MaxPriorityFeePerGas. The MaxFeePerGas represents the highest base fee a user is willing to pay to have their transaction mined. The MaxPriorityFee is the maximum amount of the MaxFee that the user is willing to “tip” to miners (assuming it is not all consumed by the base fee). The actual executing gas price is dynamically decided with the following formula, and any excess is returned to the user. GasPaid=Math.min((BaseFee+MaxPriorityFeePerGas)*GasLimit, MaxFeePerGas*GasLimit).

For example, each blockchain operation may include static blockchain operation characteristics and dynamic blockchain operation characteristics. Static blockchain operation characteristics may comprise characteristics for blockchain operations that do not depend on the current state of the blockchain network. For example, a static blockchain operation characteristic may comprise data or values that are set by a user (e.g., via user interface 100). Static blockchain operation characteristics may include blockchain operation user data (e.g., data representing an action from a user including a transfer of funds), a miner fee or priority fee (e.g., the fee required to process a transaction on the blockchain), a maximum priority fee (e.g., a maximum amount of “miner tip” per gas the user is willing to pay directly to the miner for processing the transaction), a user inputted gas limit (e.g., maximum amount of gas units a transaction is allowed to consume), and/or a max fee (e.g., a maximum amount fee per gas user is willing to pay for a transaction, which must be larger than the base fee for the transaction to go through).

In contrast, a dynamic blockchain operation characteristic may comprise a characteristic that is dependent on the current state of the blockchain network. For example, a dynamic blockchain operation characteristic may comprise a gas limit for a block on the blockchain (e.g., a maximum amount of gas units allowed in an entire block), a base fee (e.g., a minimum amount fee per gas unit needed to include a new transaction in a block, which may be set by a protocol algorithmically).

In some embodiments, a blockchain operation may comprise a swap of different cryptography-based tokens. For example, a blockchain operation may comprise the swapping of a cryptocurrency and/or other digital currency. A digital currency in which transactions are verified and records maintained by a decentralized system using cryptography, rather than by a centralized authority. In some embodiments, swapping of different cryptography-based tokens may comprise a blockchain operation across a first blockchain network and a second blockchain network. Alternatively or additionally, swapping of different cryptography-based tokens may comprise a blockchain operation on a single blockchain network.

FIG. 1B may illustrate a confirmation screen for a blockchain operation (e.g., blockchain operation 102 (FIG. 1A)) based on both static and dynamic blockchain operation characteristics. For example, user interface 110 shows a network fee, which is based on a base fee, which is a dynamic blockchain operation characteristic, and priority designation, which is a static blockchain operation characteristic. User interface 110 also includes icon 112 for canceling the pending blockchain operation, as well as icon 114 for confirming the pending blockchain operation within recommendation 116. Notably, recommendation 116 also includes information based on the data collection prior to committing the blockchain operation. For example, as shown in FIG. 1B, the system has accessed a user account and determined that an account record (e.g., an account balance) is not sufficient for the blockchain operation. As such, icon 114 is grayed out.

In some embodiments, icon 114 trigger multiple actions. For example, a user selection of icon 114 may simultaneously cause performance of a first action and a second action. For example, the first action may approve an application to access tokens in a first cryptography-based, storage application, wherein the first cryptography-based, storage application corresponds to a first private key, and wherein the first private key is stored on a first user device. The second action may cause execution of to confirm the blockchain operation. For example, the system may automatically trigger an approval to transfer a token out of a digital wallet as well as perform an actual token swap (e.g., using a decentralized exchange).

FIG. 1C illustrates user interface 120. User interface 120 includes a network fee (e.g., network fee 122), which is based on a base fee (which is a dynamic blockchain operation characteristic), and priority designation, which is a static blockchain operation characteristic. Notably, network fee 122 is expressed as a dynamic gas range. The system has generated the dynamic gas range based on static and dynamic blockchain operation characteristics. In particular, the system has generated the dynamic gas range based on the dynamic blockchain operation characteristics for the blockchain networks involved in the blockchain operation. To do so, the system may calculate the dynamic gas range based on both the static blockchain operation characteristics, as well as dynamic blockchain operation characteristics (e.g., a current base fee that is based on the state of the blockchain network).

The system may then generate a composite dynamic gas fee based on the multiple blockchain networks. For example, the system may calculate an upper bound and lower bound for the dynamic gas range using: (normalMaxFeePerGas*gas) for a lower bound and (fastMaxFeePerGas*gas) for an upper bound. The system may perform this calculation for both blockchain networks and sum the results.

For example, the system may also monitor the static blockchain operation characteristics as well as the dynamic blockchain operation characteristics. In some embodiments, the system may apply the two-tiered approach and determine that, based on the updated characteristics, the blockchain operation is likely to fail. For example, the system may monitor network conditions for a blockchain network corresponding to a cryptography-based token. The system may retrieve values (e.g., indicating network congestion, current gas limits per block, etc.). The system may then compare the current blockchain operation characteristics to the retrieved values (or confidence thresholds based on the retrieved values). For example, the system may generate one or more thresholds (e.g., a threshold corresponding to a given likelihood that a blockchain operation will be completed with the current blockchain operation characteristics). In response to determining that the thresholds are not met, the system may generate a blockchain operation processing recommendation (e.g., a warning, error, etc.). In some embodiments, the blockchain operation processing recommendation may also include recommendations for blockchain operation characteristics or values thereof to meet a given threshold.

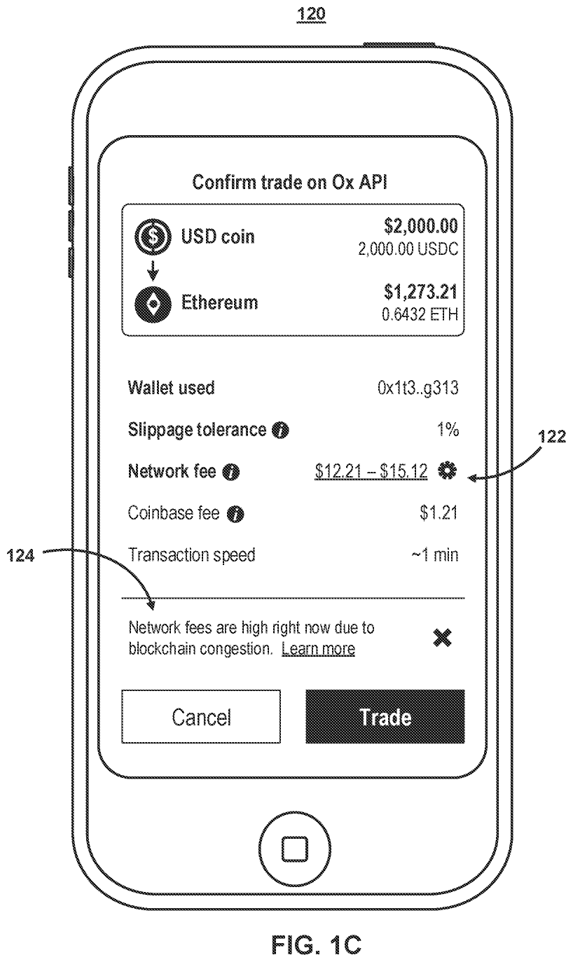

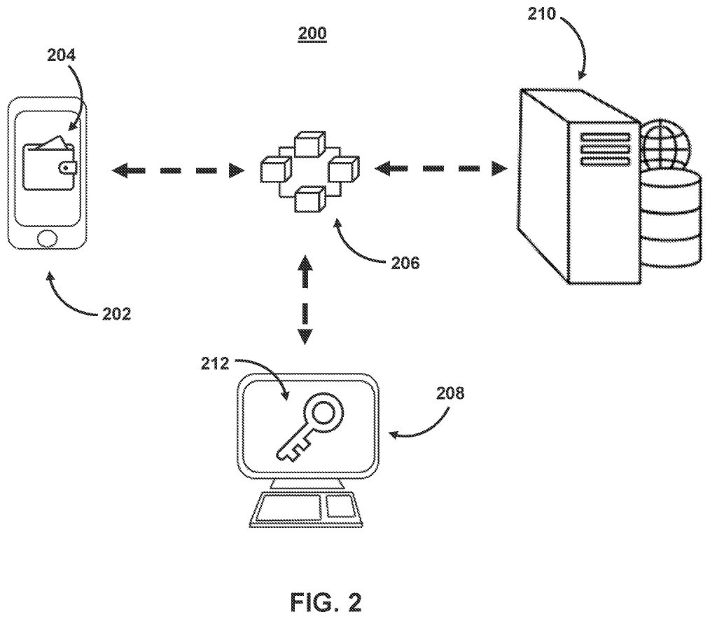

FIG. 2 shows an illustrative diagram for conducting blockchain operations, in accordance with one or more embodiments. For example, the diagram presents various components that may be used to provide the features of FIGS. 1A-C in some embodiments. FIG. 2 includes user device 202. User device 202 may include a user interface. As referred to herein, a “user interface” may comprise a mechanism for human-computer interaction and communication in a device and may include display screens, keyboards, a mouse, and the appearance of a desktop. For example, a user interface may comprise a way a user interacts with an application or website in order to access the features of FIGS. 1A-C, and the user interface may display content related to the features of FIGS. 1A-C. As referred to herein, “content” should be understood to mean an electronically consumable user asset, representations of goods or services (including nonfungible tokens), Internet content (e.g., streaming content, downloadable content, webcasts, etc.), video data, audio data, image data, and/or textual data, etc.

As shown in FIG. 2, system 200 may include multiple user devices (e.g., user device 202, user device 208, and/or user device 210). For example, system 200 may comprise a distributed state machine, in which each of the components in FIG. 2 acts as a client of system 200. For example, system 200 (as well as other systems described herein) may comprise a large data structure that holds not only all accounts and balances but also a state machine, which can change from block to block according to a predefined set of rules and which can execute arbitrary machine code. The specific rules of changing state from block to block may be maintained by a virtual machine (e.g., a computer file implemented on and/or accessible by a user device, which behaves like an actual computer) for the system.

It should be noted that, while shown as a smartphone, a personal computer, and a server in FIG. 2, the user devices may be any type of computing device, including, but not limited to, a laptop computer, a tablet computer, a hand-held computer, and/or other computing equipment (e.g., a server), including “smart,” wireless, wearable, and/or mobile devices. It should be noted that embodiments describing system 200 performing a blockchain operation may equally be applied to, and correspond to, an individual user device (e.g., user device 202, user device 208, and/or user device 210) performing the blockchain operation. That is, system 200 may correspond to the user devices (e.g., user device 202, user device 208, and/or user device 210), collectively or individually. Each of the user devices may be used by the system to conduct blockchain operations and/or contribute to the features shown in FIGS. 1A-C.

As shown in FIG. 2, one or more user devices may include a digital wallet (e.g., digital wallet 204) used to perform blockchain operations. For example, the digital wallet may comprise a repository that allows users to store, manage, and trade their cryptocurrencies and assets, interact with blockchains, and/or conduct blockchain operations using one or more applications. The digital wallet may be specific to a given blockchain protocol or may provide access to multiple blockchain protocols. In some embodiments, the system may use various types of wallets, such as hot wallets and cold wallets. Hot wallets are connected to the Internet, while cold wallets are not. Most digital wallet holders hold both a hot wallet and a cold wallet. Hot wallets are most often used to perform blockchain operations, while a cold wallet is generally used for managing a user account and may have no connection to the Internet.

As shown in FIG. 2, one or more user devices may include a private key (e.g., key 212) and/or digital signature. For example, system 200 may use cryptographic systems for conducting blockchain operations such as the features shown in FIGS. 1A-C. For example, system 200 may use public key cryptography, which features a pair of digital keys (e.g., which may comprise strings of data). In such cases, each pair comprises a public key (e.g., which may be public) and a private key (e.g., which may be kept private). System 200 may generate the key pairs using cryptographic algorithms (e.g., featuring one-way functions). System 200 may then encrypt a message (or other blockchain operation) using an intended receiver's public key such that the encrypted message may be decrypted only with the receiver's corresponding private key. In some embodiments, system 200 may combine a message with a private key to create a digital signature on the message. For example, the digital signature may be used to verify the authenticity of blockchain operations. As an illustration, when conducting blockchain operations, system 200 may use the digital signature to prove to every node in the system that it is authorized to conduct the blockchain operations.

For example, system 200 may comprise a plurality of nodes for the blockchain network. Each node may correspond to a user device (e.g., user device 208). A node for a blockchain network may comprise an application or other software that records and/or monitors peer connections to other nodes and/or miners for the blockchain network. For example, a miner comprises a node in a blockchain network that facilitates blockchain operations by verifying blockchain operations on the blockchain, adding new blocks to the existing chain, and/or ensuring that these additions are accurate. The nodes may continually record the state of the blockchain and respond to remote procedure requests for information about the blockchain.

For example, user device 208 may request a blockchain operation (e.g., conduct a transaction). The blockchain operation may be authenticated by user device 208 and/or another node (e.g., a user device in the community network of system 200). For example, using cryptographic keys, system 200 may identify users and give access to their respective user accounts (e.g., corresponding digital wallets) within system 200. Using private keys (e.g., known only to the respective users) and public keys (e.g., known to the community network), system 200 may create digital signatures to authenticate the users.

Following an authentication of the blockchain operation (e.g., using key 212), the blockchain operation may be authorized. For example, after the blockchain operation is authenticated between the users, system 200 may authorize the blockchain operation prior to adding it to the blockchain. System 200 may add the blockchain operation to blockchain 206. System 200 may perform this based on a consensus of the user devices within system 200. For example, system 200 may rely on a majority (or other metric) of the nodes in the community network (e.g., user device 202, user device 208, and/or user device 210) to determine that the blockchain operation is valid. In response to validation of the block, a node user device (e.g., user device 202, user device 208, and/or user device 210) in the community network (e.g., a miner) may receive a reward (e.g., in a given cryptocurrency) as an incentive for validating the block.

To validate the blockchain operation, system 200 may use one or more validation protocols and/or validation mechanisms. For example, system 200 may use a proof-of-work mechanism in which a user device must provide evidence that it performed computational work to validate a blockchain operation and thus this mechanism provides a manner for achieving consensus in a decentralized manner, as well as preventing fraudulent validations. For example, the proof-of-work mechanism may involve iterations of a hashing algorithm. The user device that is successful aggregates and records blockchain operations from a mempool (e.g., a collection of all valid blockchain operations waiting to be confirmed by the blockchain network) into the next block. Alternatively, or additionally, system 200 may use a proof-of-stake mechanism in which a user account (e.g., corresponding to a node on the blockchain network) is required to have, or “stake,” a predetermined amount of tokens in order for system 200 to recognize it as a validator in the blockchain network.

In response to validation of the block, the block is added to blockchain 206, and the blockchain operation is completed. For example, to add the blockchain operation to blockchain 206, the successful node (e.g., the successful miner) encapsulates the blockchain operation in a new block before transmitting the block throughout system 200.

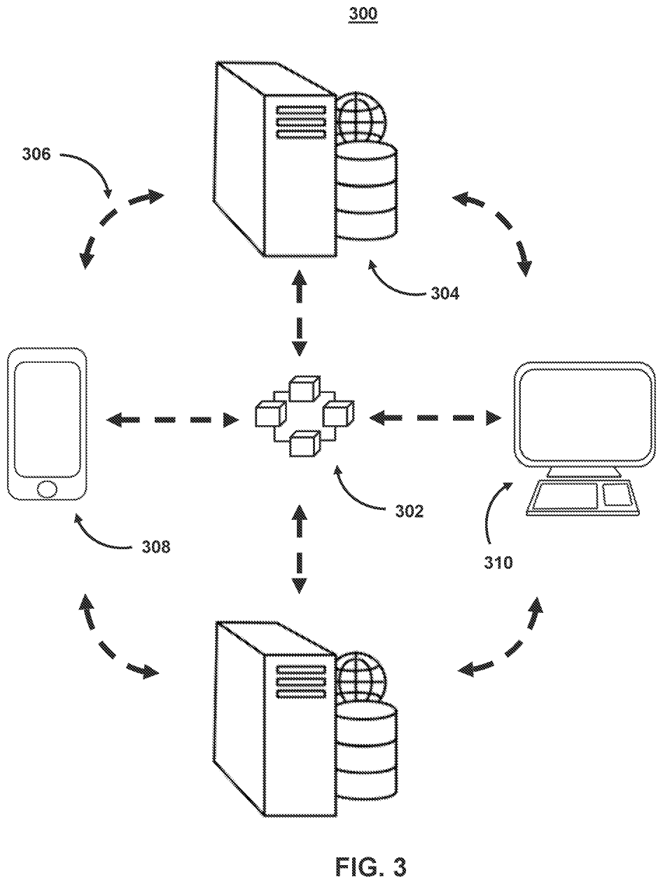

FIG. 3 shows an illustrative diagram for a decentralized application, in accordance with one or more embodiments. For example, in some embodiments, system 300 may provide the features shown in FIGS. 1A-C within a decentralized application environment. A decentralized application may comprise an application that exists on a blockchain (e.g., blockchain 302) and/or a peer-to-peer network (e.g., network 306). That is, a decentralized application may comprise an application that has a back end that is in part powered by a decentralized peer-to-peer network, such as a decentralized, open-source blockchain with smart contract functionality.

For example, network 306 may allow user devices (e.g., user device 304) within network 306 to share files and access. In particular, the peer-to-peer architecture of network 306 allows blockchain operations (e.g., corresponding to blockchain 302) to be conducted between the user devices in the network, without the need of any intermediaries or central authorities.

In some embodiments, the user devices of system 300 may comprise one or more cloud components. For example, cloud components may be implemented as a cloud computing system and may feature one or more component devices. It should also be noted that system 300 is not limited to four devices. Users may, for instance, utilize one or more devices to interact with one another, one or more servers, or other components of system 300. It should be further noted that while one or more operations (e.g., blockchain operations) are described herein as being performed by a particular component (e.g., user device 304) of system 300, those operations may, in some embodiments, be performed by other components of system 300. As an example, while one or more operations are described herein as being performed by components of user device 304, those operations may, in some embodiments, be performed by one or more cloud components. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components (e.g., user device 304 and user device 308, respectively). Additionally, or alternatively, a single user (and/or a user account linked to a single user) may interact with system 300 and/or one or more components of system 300 using two different components (e.g., user device 304 and user device 308, respectively).

With respect to the components of system 300, each of these devices may receive content and data via input/output (I/O) paths using I/O circuitry. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both user device 308 and user device 310 include a display upon which to display data (e.g., content related to one or more blockchain operations).

Additionally, the devices in system 300 may run an application (or another suitable program). The application may cause the processors and/or control circuitry to perform operations related to the features shown in FIGS. 1A-C within a decentralized application environment.

Each of these devices may also include electronic storages. The electronic storages may include non-transitory storage media that electronically stores information. The electronic storage media of the electronic storages may include one or both of (i) system storage that is provided integrally (e.g., is substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more optically readable storage media (e.g., optical disk, etc.), magnetically readable storage media (e.g., magnetic tape, magnetic hard drive, floppy drive, etc.), electrical charge-based storage media (e.g., electrically erasable programmable read-only memory (EEPROM), random access memory (RAM), etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes network 306, which may comprise communication paths between user devices. The communication paths may include the Internet, a mobile phone network, a mobile voice or data network (e.g., a 5G or LTE network), a cable network, a public switched telephone network, or other types of communication networks or combinations of communication networks. The communication paths may separately or together include one or more communication paths, such as a satellite path, a fiber-optic path, a cable path, a path that supports Internet communications (e.g., Internet protocol television), free-space connections (e.g., for broadcast or other wireless signals), or any other suitable wired or wireless communication path or combination of such paths. The computing devices may include additional communication paths linking a plurality of hardware, software, and/or firmware components operating together. For example, the computing devices may be implemented by a cloud of computing platforms operating together as the computing devices.

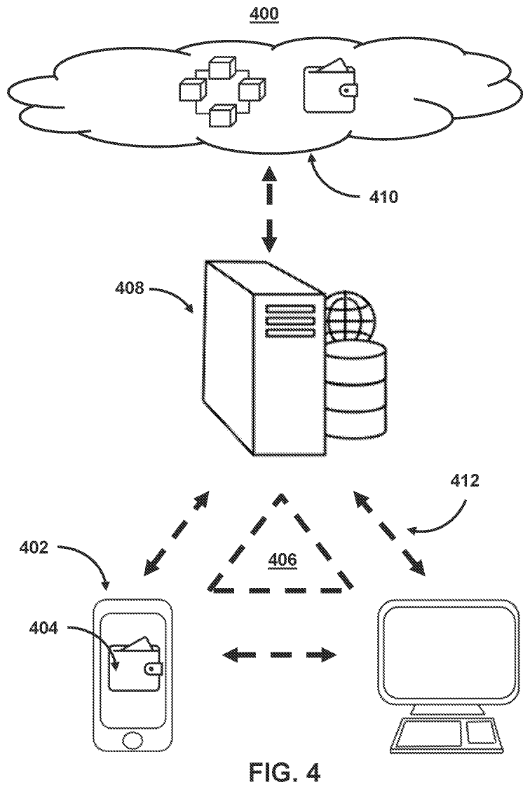

FIG. 4 shows an illustrative diagram for conducting operations in a decentralized application using blockchain operations, in accordance with one or more embodiments. For example, system 400 may include user device 402. Furthermore, user device 402 may comprise an application (e.g., application 404) that is implemented on, and/or accessible by, user device 402. For example, application 404 may interact with one or more other applications and/or APIs in order to provide the features shown in FIGS. 1A-C. For example, application 404 may comprise a decentralized application digital wallet and/or wallet service that is able to sign and send transactions to transfer tokens and/or perform other blockchain operations, as well as interact with one or more decentralized applications.

System 400 also includes API layer 406. In some embodiments, API layer 406 may be implemented on user device 402. Alternatively, or additionally, API layer 406 may reside on one or more cloud components (e.g., server 408). For example, API layer 406 may reside on a server 408 and comprise a platform service for a custodial wallet service, decentralized application, etc. API layer 406 (which may be a representational state transfer (REST) or web services API layer) may provide a decoupled interface to data and/or functionality of one or more applications.

API layer 406 may provide various low-level and/or blockchain-specific operations in order to facilitate the features shown in FIGS. 1A-C. For example, API layer 406 may provide blockchain operations such as blockchain writes. Furthermore, API layer 406 may perform a transfer validation ahead of forwarding the blockchain operation (e.g., a transaction) to another service (e.g., a crypto service). API layer 406 may then log the outcome. For example, by logging to the blockchain prior to forwarding, the API layer 406 may maintain internal records and balances without relying on external verification (e.g., which may take up to ten minutes based on blockchain updating activity).

API layer 406 may also provide informational reads. For example, API layer 406 (or a platform service powered by API layer 406) may generate blockchain operation logs and write to an additional ledger (e.g., an internal record and/or indexer service) the outcome of the reads. If this is done, a user accessing the information through other means may see consistent information such that downstream users ingest the same data point as the user.

API layer 406 may also provide a unified API to access balances, transaction histories, and/or other blockchain operations activity records between one or more decentralized applications and custodial user accounts. By doing so, the system maintains the security of sensitive information, such as balance and transaction history. Alternatively, a mechanism for maintaining such security would separate the API access between the decentralized applications and custodial user accounts through the use of special logic. The introduction of the special logic decreases the streamlining of the system, which may result in system errors based on divergence and reconciliation.

API layer 406 may provide a common, language-agnostic way of interacting with an application. In some embodiments, API layer 406 may comprise a web services API that offers a well-defined contract that describes the services in terms of their operations and the data types used to exchange information. REST APIs do not typically have this contract; instead, they are documented with client libraries for most common languages, including Ruby, Java, PHP, and JavaScript. Simple object access protocol (SOAP) web services have traditionally been adopted in the enterprise for publishing internal services, as well as for exchanging information with partners in business-to-business (B2B) transactions.

API layer 406 may use various architectural arrangements. For example, system 400 may be partially based on API layer 406, such that there is strong adoption of SOAP and RESTful web services, using resources such as Service Repository and Developer Portal, but with low governance, standardization, and separation of concerns. Alternatively, system 400 may be fully based on API layer 406, such that separation of concerns between layers such as API layer 406, services, and applications are in place.

In some embodiments, the system architecture may use a microservice approach. Such systems may use two types of layers: front-end layers and back-end layers, where microservices reside. In this kind of architecture, the role of the API layer 406 may be to provide integration between front-end and back-end layers. In such cases, API layer 406 may use RESTful APIs (exposition to front-end or even communication between microservices). API layer 406 may use the advanced message queuing protocol (AMQP), which is an open standard for passing business messages between applications or organizations. API layer 406 may use an open-source, high-performance remote procedure call (RPC) framework that may run in a decentralized application environment. In some embodiments, the system architecture may use an open API approach. In such cases, API layer 406 may use commercial or open-source API platforms and their modules. API layer 406 may use a developer portal. API layer 406 may use strong security constraints applying a web application firewall that protects the decentralized applications and/or API layer 406 against common web exploits, bots, and denial-of-service (DDoS) attacks. API layer 406 may use RESTful APIs as standard for external integration.

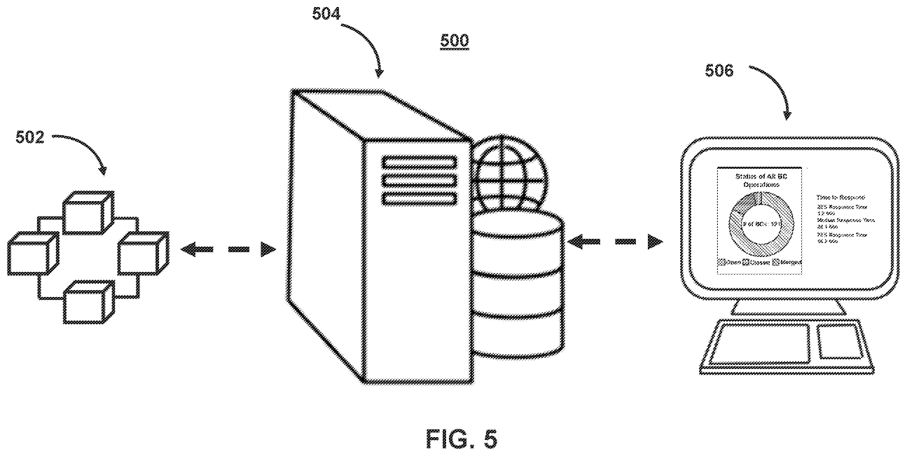

As shown in FIG. 4, system 400 may use API layer 406 to communicate with and/or facilitate blockchain operations with server 408. For example, server 408 may represent a custodial platform for blockchain operations. A custodial platform may manage private keys stored by a centralized service provider (e.g., server 408). In such cases, server 408 may interact with blockchain 410, a wallet service for blockchain 410, an indexer service for blockchain 410 (e.g., as described in FIG. 5), and/or other platform services.

For example, a wallet service may comprise an application and/or a software-based system that securely stores users' payment information, private keys, and/or passwords facilitating blockchain operations with websites, nodes, and/or other devices. In some embodiments, a wallet service may also provide additional ledger access (e.g., a second ledger). Furthermore, as discussed above, this second ledger may receive updates directly from API layer 406, as opposed to relying on data pulled directly from blockchain 410.

For example, system 400 may maintain its records (e.g., both live and for accounting) in good order separate from balances on blockchain 410. That is, system 400 may maintain an architecture featuring the second ledger, where balances are stored and updated, and the logs of blockchain operations. While conventional systems may rely on directly referencing blockchain 410, since the blockchain is the source of truth for the system, however, such reliance leads to additional technical problems.

First, there is a strong likelihood of impedance mismatch between a format for a platform service and the APIs used to retrieve data from the blockchain (e.g., which may lead to accounting imbalances). For example, system 400 may need to be able to generate accounting entries reflecting changes of balances. However, while changes of balances can be tracked by examining blockchain 410, this requires additional processing and computational power.

Second, accounting changes in a blockchain architecture should be irreversible. This is achieved in practice for current blockchain operations by waiting for a variable number of confirmations from the blockchain (e.g., blockchain 410). By waiting for the variable number of confirmations, the likelihood of an error in the blockchain becomes infinitesimally small. However, while blockchain services rely on this methodology, this is not a rule inherent to the blockchain itself. That is, the blockchain does not have an inherent authentication mechanism that is dependent on a number of confirmations. Instead, the blockchain relies on an absolute system—blockchain operations are either recorded on a particular node or they are not.

As such, forks in the blockchain are always possible. In the case of a fork, system 400 may not follow the “right” fork for an undetermined amount of time. If that happens, and if, for the purpose of a custodial digital wallet, system 400 decides to move from one fork to another, system 400 may have a more straightforward mechanism to maintain an accurate history of a user account's positions if system 400 stores them independently from a given blockchain. Furthermore, in case of forks, system 400 performs some internal remediation on user accounts, which is enabled by system 400 maintaining a layer of insulation from the blockchain, for remedial blockchain operations. For example, system 400 may have a separate storage, protected by the second ledger (e.g., a ledger service), for reads, and by a transfer service, for writes, that reflect the state of the blockchain that is relevant for system 400 purposes.

In some embodiments, the system may also use one or more application binary interfaces (ABIs). An ABI is an interface between two program modules, often between operating systems and user programs. ABIs may be specific to a blockchain protocol. For example, an Ethereum virtual machine (EVM) is a core component of the Ethereum network, and a smart contract may be a piece of code stored on the Ethereum blockchain, which are executed on EVM. Smart contracts written in high-level languages such as Solidity or Vyper, may be compiled in EVM executable bytecode by the system. Upon deployment of the smart contract, the bytecode is stored on the blockchain and is associated with an address. To access functions defined in high-level languages, the system translates names and arguments into byte representations for bytecode to work with it. To interpret the bytes sent in response, the system converts back to the tuple (e.g., a finite ordered list of elements) of return values defined in higher-level languages. Languages that compile for the EVM maintain strict conventions about these conversions, but in order to perform them, the system must maintain the precise names and types associated with the operations. The ABI documents these names and types precisely and, in an easily parseable format, doing translations between human-intended method calls and smart contract operations that are discoverable and reliable.

For example, ABI defines the methods and structures used to interact with the binary contract similar to an API, but on a lower level. The ABI indicates to the caller of the function to encode (e.g., ABI encoding) the needed information, such as function signatures and variable declarations in a format that the EVM can understand, to call that function in bytecode. ABI encoding may be automated by the system using compilers or wallets interacting with the blockchain.

FIG. 5 shows an illustrative diagram for a blockchain indexer, in accordance with one or more embodiments. For example, in some embodiments, the system may use indexer service 500 to provider features described in FIGS. 1A-C. Indexer service 500 may fetch raw data (e.g., data related to a current state and/or instance of blockchain 502) from a node of a blockchain network (e.g., as described above). Indexer service 500 may then process the data and store it in a database and/or data structure in an efficient way to provide quick access to the data. For example, indexer 504 may publish and/or record a subset of blockchain operations that occur for blockchain 502. Accordingly, for subsequent blockchain operations, indexer service 500 may reference the index at indexer 504 as opposed to a node of blockchain 502 to provide various services at user device 506.

For example, indexer 504 may store a predetermined list of blockchain operations to monitor for and/or record in an index. These may include blockchain operations (e.g., “operation included,” “operation removed,” or “operation finalized”) related to a given type of blockchain operation (e.g., “transaction,” “external transfer,” “internal transfer,” “new contract metadata,” “ownership change,” etc.), as well as blockchain operations related to a given protocol, protocol subgroup, and/or other characteristic (e.g., “ETH,” “ERC20,” and/or “ERC721”). Additionally and/or alternatively, the various blockchain operations and metadata related to those blockchain operations (e.g., block designations, user accounts, time stamps, etc.), as well as an aggregate of multiple blockchain operations (e.g., total blockchain operations amounts, rates of blockchain operations, rate of blockchain updates, etc.) may be monitored and/or recorded. Indexer 504 may likewise provide navigation and search features (e.g., support Boolean operations) for the indexed blockchain operations. In some embodiments, indexer 504 may apply one or more formatting protocols to generate representations of indexed blockchain operations in a human-readable format. In some embodiments, indexer 504 may also tag blockchain operations based on whether or not the blockchain operation originated for a local user account (e.g., a user account corresponding to a custodial account) and/or a locally hosted digital wallet. Indexer service 500 may determine whether a blockchain operation contains relevant information for users of indexer service 500 by storing information about whether an address is an internal address of indexer service 500 or one used in a digital wallet hosted by a predetermined wallet service.

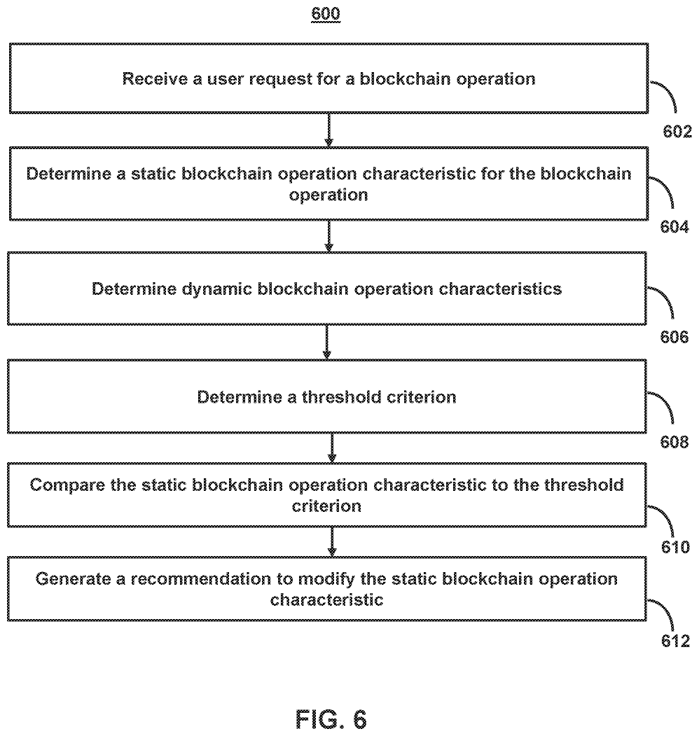

FIG. 6 shows a flowchart of the steps involved in facilitating blockchain operations, in accordance with one or more embodiments. For example, the system may use process 600 (e.g., as implemented on one or more system components described above) in order to provide the features described in FIGS. 1A-C. The system may use one or more components to perform process 600. For example, the system may comprise a first cryptography-based, storage application, wherein the first cryptography-based, storage application corresponds to a first private key, and wherein the first private key is stored on a user device. The system may also comprise a second cryptography-based, storage application, wherein the second cryptography-based, storage application corresponds to a first partial private key and a second partial private key, wherein the first partial private key is stored on a remote device network, and wherein the second partial private key is stored on the user device. The system may comprise and/or query a blockchain node, wherein the blockchain node verifies batches of blockchain operations, and wherein each batch of the batches comprises a plurality of blockchain operations involving the first cryptography-based, storage application and the second cryptography-based, storage application. Additionally, or alternatively, the system may also use a cryptography-based, indexing application, wherein the cryptography-based, indexing application comprises a queryable record of a subset of blockchain operations occurring on the blockchain network.

It should be noted that while process 600 describes a blockchain operation across a first and second blockchain network, process 600 is also applicable to a blockchain operation on a single blockchain network. For example, some blockchain operations may occur across multiple blockchain networks (e.g., different blockchain protocols, mainchains and sidechains, etc.) and/or be subject to fees (e.g., gas fees) for conducting the blockchain operation on the respective networks.

Other blockchain operations may occur on a single blockchain network. Nonetheless, blockchain operations occurring on a single blockchain network may also include fees related to different portions of the blockchain operation. For example, a blockchain operation that uses a decentralized exchange may include fees that are attributed to the use of the decentralized exchange (e.g., fees split between liquidity provides, protocol fees, etc.).

In either case, the system may run a simulation of the network conditions on one or more blockchain networks in order to determine current network congestion data. For example, the system may use a simulation test different decentralize finance protocols without using actual account information or using currency (e.g., whether digital or fiat). The system may process the blockchain operation in the simulated environment to determine network congestion data.

At step 602, process 600 (e.g., using one or more components described above) receives a user request for a blockchain operation. For example, the system may receive, at a first user device, a first user request to execute a blockchain operation, across a first blockchain network and a second blockchain network, in a decentralized exchange using a first cryptography-based, storage application. The first cryptography-based, storage application may be used to perform a plurality of blockchain operations across a computer network based on a combined use of a first public key, a first partial private key, and a second partial private key, and wherein the second partial private key is not accessible to a platform service facilitating the first cryptography-based, storage application.

At step 604, process 600 (e.g., using one or more components described above) determines a static blockchain operation characteristic for the blockchain operation. For example, the system may, in response to receiving the first user request, determine a first static blockchain operation characteristic for the blockchain operation, wherein the first static blockchain operation characteristic is based on a first user input. For example, the first static blockchain operation characteristic for the blockchain operation may comprise determining a max fee.

At step 606, process 600 (e.g., using one or more components described above) determines dynamic blockchain operation characteristics. In some embodiments, the system may determine dynamic blockchain operation characteristics for one or more portions of the blockchain operations. For example, if the blockchain operation occurs over multiple blockchain networks, the system may determine a plurality of dynamic blockchain operation characteristics for a plurality of blockchain networks, in which each of the plurality of dynamic blockchain operation characteristics is based on respective network congestion data.

For example, the system may retrieve first network congestion data from the first blockchain network. The system may then determine a first dynamic blockchain operation characteristic (e.g., a first network fee) based on the first network congestion data. Additionally, the system may retrieve second network congestion data from the second blockchain network. The system may then determine a second dynamic blockchain operation characteristic (e.g., a second network fee) based on the second network congestion data. For example, the first threshold criterion may comprise a network or base fee.

In such cases, the system may determine if the max fee is less than or equal to a base fee. For example, the system may not confirm the blockchain operation until the base fee drops to match the max fee. When these two values are determined to match, the system may confirm the blockchain operation at approximately the max value.

Alternatively or additionally, the system may retrieve first network congestion data for a first portion of blockchain operation. The system may then determine a first dynamic blockchain operation characteristic (e.g., a first network fee, a first for a centralized exchange, etc.) based on the first network congestion data (e.g., a gas fee, a transaction fee for a decentralized exchange, etc.). Additionally, the system may retrieve second network congestion data for a second portion of blockchain operation. The system may then determine a second dynamic blockchain operation characteristic (e.g., a second network fee, a second fee for a centralized exchange) based on the second network congestion data (e.g., a second gas fee, a second transaction fee for a decentralized exchange, etc.).

For example, the system may run a simulation of the network conditions on one or more blockchain networks in order to determine current network congestion data. For example, the system may use a simulation test different decentralize finance protocols without using actual account information or using currency (e.g., whether digital or fiat). The system may process the blockchain operation in the simulated environment to determine network congestion data.

At step 608, process 600 (e.g., using one or more components described above) determines a threshold criterion. For example, the system may determine a first threshold criterion based on the first dynamic blockchain operation characteristic and the second dynamic blockchain operation characteristic.

At step 610, process 600 (e.g., using one or more components described above) compares the static blockchain operation characteristic to the threshold criterion. For example, the system may compare the first static blockchain operation characteristic to the first threshold criterion to determine whether the first static blockchain operation characteristic equals or exceeds the first threshold criterion.

At step 612, process 600 (e.g., using one or more components described above) generates a recommendation to modify the static blockchain operation characteristic. For example, the system may, in response to determining that the first static blockchain operation characteristic does not equal or exceed the first threshold criterion, generate for display, in a user interface at the first user device, a first recommendation to modify the first static blockchain operation characteristic.

In some embodiments, the system may generate other recommendations, such as recommendations to execute a blockchain operation, recommendations to modify the blockchain operation, and/or recommendations to cancel the blockchain operation. For example, in response to determining that the first static blockchain operation characteristic equals or exceeds the first threshold criterion, the system may determine a second static blockchain operation characteristic for the blockchain operation, wherein the second static blockchain operation characteristic is based on a second user input. The system may then determine a composite dynamic gas range for the blockchain operation across the first blockchain network and the second blockchain network, wherein the composite dynamic gas range comprises a composite lowerbound and a composite upperbound, and wherein the composite dynamic gas range is based on the first static blockchain operation characteristic, the first dynamic blockchain operation characteristic, and the second dynamic blockchain operation characteristic.

For example, the second static blockchain operation characteristic may comprise a priority designation. In such cases, the system may determine if the max fee is less than or equal to the base fee and the max priority fee (e.g., based on the priority designation). For example, the system may confirm the blockchain operation as long as the base fee remains lower than the max fee and any remaining gas will be consumed as a priority fee. The system may then be confirmed at a specific fee, and the system may not display a gas range.

The system may generate the composite dynamic gas range based on blockchain operation characteristics for multiple blockchain networks. For example, the composite dynamic gas range may comprise a composite lowerbound and a composite upperbound, wherein the composite dynamic gas range is based on the first static blockchain operation characteristic, the first dynamic blockchain operation characteristic, and the second dynamic blockchain operation characteristic. For example, the system may determine a first lowerbound for the blockchain operation based on the first dynamic blockchain operation characteristic. The system may determine a second lowerbound for the blockchain operation based on the second dynamic blockchain operation characteristic. The system may then determine the composite lowerbound of the composite dynamic gas range is based on summing the first lowerbound and the second lowerbound.

Additionally, or alternatively, the system may determine a first upperbound for the blockchain operation based on the first dynamic blockchain operation characteristic. The system may determine a second upperbound for the blockchain operation based on the second dynamic blockchain operation characteristic. The system may then determine the composite upperbound of the composite dynamic gas range is based on summing the first upperbound and the second upperbound.

In some embodiments, the second user input may indicate a priority designation for the blockchain operation. For example, to determine the composite dynamic gas range, the system may determine a third static blockchain operation characteristic for the blockchain operation based on the second static blockchain operation characteristic, wherein the third static blockchain operation characteristic comprises a first max priority fee for the first blockchain network. The system may determine a fourth static blockchain operation characteristic for the blockchain operation based on the second static blockchain operation characteristic, wherein the fourth static blockchain operation characteristic comprises a second max priority fee for the second blockchain network. The system may determine a second threshold criterion based on a sum of the third static blockchain operation characteristic, the fourth static blockchain operation characteristic, and the first threshold criterion.

The recommendation may also indicate an error with a potential blockchain operation. For example, the system may perform verifications and validations on data in a piecemeal manner such that errors and/or network conditions affecting the blockchain operation may be detected prior to the blockchain operation being confirmed. Thus, the system may generate warnings and/or recommendations to mediate error before a blockchain operation is confirmed. For example, the system may generate an error message if an account record (e.g., a record of a digital asset balance) is too low.

For example, the system may access a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations. The system may retrieve, from the user account, an account record. The system may compare the account record to the second threshold criterion to determine whether the account record equals or exceeds the second threshold criterion. The system may, in response to determining that the account record does not equal or exceed the second threshold criterion, generate for display, in the user interface at the first user device, a second recommendation to modify one or more static blockchain operation characteristics of the blockchain operation.

The recommendation may also recommend delaying a blockchain operation (e.g., until better network conditions are available). For example, by delaying until network congestion is lower, the system may execute a blockchain operation with lower network fees. The system may determine this based on analyzing historic information. For example, the system may generate the plurality of respective values for the first type of blockchain operation characteristics. In some embodiments, the plurality of respective values for static blockchain operation characteristics correspond to a plurality of respective priority designations.

In some embodiments, the system may use preset values (e.g., in the API) to determine the respective values. In some embodiments, the system may retrieve historic blockchain operations and determine a value (or average value) corresponding to the completed blockchain operations. For example, the system may determine (e.g., with a given confidence) a value (e.g., a priority fee) corresponding to an average blockchain operation (e.g., over the past several blocks or time period) that was completed. The system may then use this value for the respective value and/or based the respective value off of these values. For example, the system may retrieve records for completed blockchain operations of a given time period. The system may determine values corresponding to the first type of blockchain operation characteristics for the records. The system may then determine the plurality of respective values for static blockchain operation characteristics for the plurality of blockchain operation processing recommendations based on the values corresponding to the first type of blockchain operation characteristics for the records.

For example, in response to retrieving the first network congestion data from the first blockchain network, the system may retrieve historic network congestion data for the first blockchain network. The system may compare the first network congestion data to the historic network congestion data to determine if the first network congestion data exceeds the historic network congestion data. The system may, in response to determining that the first network congestion data exceeds the historic network congestion data, generate for display, in the user interface at the first user device, a fourth recommendation to delay the blockchain operation.

In another example, in response to determining the third static blockchain operation characteristic (e.g., a priority designation), the system may retrieve a historic max priority fee for the first blockchain network for a corresponding priority. The system may compare the third static blockchain operation characteristic to the historic max priority fee to determine if the third static blockchain operation characteristic exceeds the historic max priority fee. The system may, in response to determining that the third static blockchain operation characteristic exceeds the historic max priority fee, generate for display, in the user interface at the first user device, a third recommendation to delay the blockchain operation.

The recommendation may also recommend executing a blockchain operation. For example, the system may determine that the network conditions are favorable and recommend committing a pending blockchain operation. In such cases, the system may receive, at the first user device, a second user request confirming execution of the blockchain operation. The system may determine an actual gas fee for the blockchain operation. The system may conduct the blockchain operation with the actual gas fee using the first cryptography-based, storage application.

To execute the blockchain operation, the system may access a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations. The system may retrieve, from the user account, a first partial private key and a user address. The system may query a user device for use of a second partial private key in performing the blockchain operation. The system may generate a first digital signature based on the first partial private key and the second partial private key. The system may perform the blockchain operation based on the first digital signature and the user address.

For example, in some embodiments, the signing process may include multi-party computation (e.g., MPC). MPC involves the use of multiple parties, each of which holds respective private data that may be used to evaluate a computation without ever revealing any of the private data held by each party. For example, each party of the multiple parties may possess private data (e.g., d₁, d₂, . . . d_{N}). Together, the parties may use their respective private data to compute a value of a public function: (e.g., F(d₁, d₂, . . . d_{N})). While the private data is used to compute a value based on the function, the private data is kept private during that process.

The use of an MPC-based key lessens the risk involved with the loss of a private key and/or the private key being accessed by unauthorized parties. For example, conventional key-share systems rely on a public-private key configuration where the security of the system is tied to the private key remaining private. In some cases, these keys are stored in various cryptography-based digital repositories (e.g., digital wallets). These digital wallets may have various configurations, typically categorized by whether the private key is held online or offline. For example, a hot storage wallet has a private key held online. A cold storage wallet has a private key held offline, and a hardware wallet has a private key held offline and on a physical device (e.g., a thumb drive). While holding a private key offline and/or tying the private key to a physical device is beneficial from a security perspective, this creates practical problems when attempting to conduct operations using the digital wallet. For example, to conduct an operation, a user must be able to access the private key from its offline location and/or the physical device. This is particularly burdensome for MPC-based key operations as it requires each user (e.g., corresponding to a respective private key) to be available at a given time.

Furthermore, the use of a private key stored at an offline location and/or on the physical device increases the risk that the offline location becomes inaccessible and/or the physical device is lost. In such cases, the digital wallet and any digital assets therein may be lost as well. This creates a critical flaw in MPC-based key operations, as the loss of any one key may result in the loss of digital assets for all of the parties. The methods and systems described herein overcome this problem through the use of threshold signing requirements, separate approval and signing policies, independent key recovery mechanisms, and cohort/group key creation. More specifically, the methods and systems described herein alleviate flaws in the MPC-based key operations by creating MPC-based key operations in which the MPC relies on partial private keys. In such cases, a partial private key is maintained online (e.g., in a hot wallet), whereas other partial private keys may remain offline. Furthermore, due to the use of the partial private keys, the exposure of the online partial private key does not in and of itself create a security risk (e.g., as multiple partial private keys, including an offline partial key, are required for conducting blockchain operations), and the loss of the offline partial private key (e.g., stored on a user device) does not create a risk of the loss of digital assets (e.g., as the online partial private key may be used to recover the offline private partial key).

The MPC-based key operations maintain flexibility in the algorithm used. For example, the system may use online MPC algorithms, such as the Gennaro and Goldfeder MPC algorithm and the Lindell et al. MPC algorithm. The online MPC algorithms have two limitations that restrict their use in conventional systems. First, they require users to wait for blockchain operations to undergo up to 8 to 12 signature rounds, which can create latency issues. Second, they require the use of online storage for private keys. Due to the use of partial private keys (e.g., comprising an online and offline pair), the system may use online MPC algorithms. Furthermore, given that the online requirement for the online MPC algorithms is satisfied by the online partial private key, the system may use the online MPC algorithms while maintaining the offline partial private key (e.g., increasing overall security).

Additionally, the MPC-based key operations used by the system may include offline and/or online hybrid MPC algorithms. For example, the system may use MPC algorithms that include dynamic key refreshes (e.g., private key shares may be dynamically updated/modified at a given interval) and/or dynamic approval and/or signing policies. These dynamic policies are made possible by the online partial private key. Thus, the system introduces the enhanced security of dynamic systems, while still maintaining the security of offline systems (e.g., through the use of the offline partial private key).

Finally, the MPC-based key operations may use threshold key-signing policies in which only a threshold number of users (e.g., partial private keys corresponding to a user) are required. Upon determination by the system that the threshold is met, the system may allow a subsequent user (e.g., an online user) to finalize and perform a blockchain operation. As such, the system allows for the use of MPC-based key operations without requiring all parties to be online and/or available at the same time.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 6.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method, the method comprising: receiving, at a first user device, a first user request to execute a blockchain operation, across a first blockchain network and a second blockchain network, in a decentralized exchange using a first cryptography-based, storage application; in response to receiving the first user request, determining a first static blockchain operation characteristic for the blockchain operation, wherein the first static blockchain operation characteristic is based on a first user input; retrieving first network congestion data from the first blockchain network; determining a first dynamic blockchain operation characteristic based on the first network congestion data; retrieving second network congestion data from the second blockchain network; determining a second dynamic blockchain operation characteristic based on the second network congestion data; determining a first threshold criterion based on the first dynamic blockchain operation characteristic and the second dynamic blockchain operation characteristic; comparing the first static blockchain operation characteristic to the first threshold criterion to determine whether the first static blockchain operation characteristic equals or exceeds the first threshold criterion; and in response to determining that the first static blockchain operation characteristic does not equal or exceed the first threshold criterion, generating for display, in a user interface at the first user device, a first recommendation to modify the first static blockchain operation characteristic.
2. The method of the preceding embodiment, wherein the method is for facilitating blockchain operations across multiple blockchain networks using decentralized exchanges.
3. The method of any preceding embodiment, further comprising: in response to determining that the first static blockchain operation characteristic equals or exceeds the first threshold criterion, determining a second static blockchain operation characteristic for the blockchain operation, wherein the second static blockchain operation characteristic is based on a second user input; and determining a composite dynamic gas range for the blockchain operation across the first blockchain network and the second blockchain network, wherein the composite dynamic gas range comprises a composite lowerbound and a composite upperbound, and wherein the composite dynamic gas range is based on the first static blockchain operation characteristic, the first dynamic blockchain operation characteristic, and the second dynamic blockchain operation characteristic.
4. The method of any preceding embodiment, further comprising: determining a first lowerbound for the blockchain operation based on the first dynamic blockchain operation characteristic; determining a second lowerbound for the blockchain operation based on the second dynamic blockchain operation characteristic; and determining the composite lowerbound of the composite dynamic gas range is based on summing the first lowerbound and the second lowerbound.
5. The method of any preceding embodiment, further comprising: determining a first upperbound for the blockchain operation based on the first dynamic blockchain operation characteristic; determining a second upperbound for the blockchain operation based on the second dynamic blockchain operation characteristic; and determining the composite upperbound of the composite dynamic gas range is based on summing the first upperbound and the second upperbound.
6. The method of any preceding embodiment, wherein the second user input indicates a priority designation for the blockchain operation, and wherein determining the composite dynamic gas range further comprises: determining a third static blockchain operation characteristic for the blockchain operation based on the second static blockchain operation characteristic, wherein the third static blockchain operation characteristic comprises a first max priority fee for the first blockchain network; determining a fourth static blockchain operation characteristic for the blockchain operation based on the second static blockchain operation characteristic, wherein the fourth static blockchain operation characteristic comprises a second max priority fee for the second blockchain network; and determining a second threshold criterion based on a sum of the third static blockchain operation characteristic, the fourth static blockchain operation characteristic, and the first threshold criterion.
7. The method of any preceding embodiment, further comprising: accessing a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations; retrieving, from the user account, an account record; comparing the account record to the second threshold criterion to determine whether the account record equals or exceeds the second threshold criterion; and in response to determining that the account record does not equal or exceed the second threshold criterion, generating for display, in the user interface at the first user device, a second recommendation to modify one or more static blockchain operation characteristics of the blockchain operation.
8. The method of any preceding embodiment, further comprising: in response to determining the third static blockchain operation characteristic, retrieving a historic max priority fee for the first blockchain network; comparing the third static blockchain operation characteristic to the historic max priority fee to determine if the third static blockchain operation characteristic exceeds the historic max priority fee; and in response to determining that the third static blockchain operation characteristic exceeds the historic max priority fee, generating for display, in the user interface at the first user device, a third recommendation to delay the blockchain operation.
9. The method of any preceding embodiment, further comprising: receiving, at the first user device, a second user request confirming execution of the blockchain operation; determining an actual gas fee for the blockchain operation; and conducting the blockchain operation with the actual gas fee using the first cryptography-based, storage application.
10. The method of any preceding embodiment, further comprising: accessing a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations; retrieving, from the user account, a first partial private key and a user address; querying user device for use of a second partial private key in performing the blockchain operation; generating a first digital signature based on the first partial private key and the second partial private key; and performing the blockchain operation based on the first digital signature and the user address.
11. The method of any preceding embodiment, further comprising: in response to retrieving the first network congestion data from the first blockchain network, retrieving historic network congestion data for the first blockchain network; comparing the first network congestion data to the historic network congestion data to determine if the first network congestion data exceeds the historic network congestion data; and in response to determining that the first network congestion data exceeds the historic network congestion data, generating for display, in the user interface at the first user device, a fourth recommendation to delay the blockchain operation.
12. The method of any preceding embodiment, further comprising: receiving a second user request, wherein the second user request simultaneously performs a first action and a second action, wherein the first action approves an application to access a first cryptography-based, storage application, wherein the first cryptography-based, storage application corresponds to a first private key, and wherein the first private key is stored on a first user device, and wherein the second action causes execution of to confirm the blockchain operation.
13. A tangible, non-transitory, machine-readable medium storing instructions that, when executed by a data processing apparatus, cause the data processing apparatus to perform operations comprising any preceding embodiment.
14. A system comprising one or more processors; and memory storing instructions that, when executed by the processors, cause the processors to effectuate operations comprising any preceding embodiment.
15. A system comprising means for performing any of the preceding embodiments.

1. A system for facilitating blockchain operations across multiple blockchain networks using cryptographically-secured decentralized exchanges, the system comprising:
a first cryptography-based, storage application, wherein the first cryptography-based, storage application corresponds to a first private key, and wherein the first private key is stored on a first user device;
a second cryptography-based, storage application, wherein the second cryptography-based, storage application corresponds to a first partial private key and a second partial private key, wherein the first partial private key is stored on a remote device network, and wherein the second partial private key is stored on the first user device;
a blockchain node, wherein the blockchain node verifies batches of blockchain operations, and wherein each batch of the batches comprises a plurality of blockchain operations involving the first cryptography-based, storage application and the second cryptography-based, storage application; and
one or more processors; and one or more non-transitory computer-readable media storing instruction that, when executed by the one or more processors, cause operations comprising:
receiving, at the first user device, a first user request to execute a blockchain operation, across a first blockchain network and a second blockchain network, in a decentralized exchange using the first cryptography-based, storage application;
in response to receiving the first user request, determining a first static blockchain operation characteristic for the blockchain operation, wherein the first static blockchain operation characteristic is based on a first user input;
retrieving first network congestion data from the first blockchain network;
determining a first dynamic blockchain operation characteristic based on the first network congestion data;
retrieving second network congestion data from the second blockchain network;
determining a second dynamic blockchain operation characteristic based on the second network congestion data;
determining a first threshold criterion based on the first dynamic blockchain operation characteristic and the second dynamic blockchain operation characteristic;
comparing the first static blockchain operation characteristic to the first threshold criterion to determine whether the first static blockchain operation characteristic equals or exceeds the first threshold criterion;
in response to determining that the first static blockchain operation characteristic does not equal or exceed the first threshold criterion, generating for display, in a user interface at the first user device, a first recommendation to modify the first static blockchain operation characteristic; and
in response to determining that the first static blockchain operation characteristic equals or exceeds the first threshold criterion:
determining a second static blockchain operation characteristic for the blockchain operation, wherein the second static blockchain operation characteristic is based on a second user input; and
determining a composite dynamic gas range for the blockchain operation across the first blockchain network and the second blockchain network, wherein the composite dynamic gas range comprises a composite lowerbound and a composite upperbound, and wherein the composite dynamic gas range is based on the first static blockchain operation characteristic, the first dynamic blockchain operation characteristic, and the second dynamic blockchain operation characteristic.

2-12. (canceled)

13. One or more non-transitory, computer readable media having instructions recorded thereon, that, when executed by one or more processors, causes operations comprising:
receiving, at a first user device, a first user request to execute a blockchain operation in a decentralized exchange using a first cryptography-based, storage application;
in response to receiving the first user request, determining a first static blockchain operation characteristic for the blockchain operation, wherein the first static blockchain operation characteristic is based on a first user input;
determining a first dynamic blockchain operation characteristic;
determining a second dynamic blockchain operation characteristic;
determining a first threshold criterion based on the first dynamic blockchain operation characteristic and the second dynamic blockchain operation characteristic;
comparing the first static blockchain operation characteristic to the first threshold criterion to determine whether the first static blockchain operation characteristic equals or exceeds the first threshold criterion; and
in response to determining that the first static blockchain operation characteristic does not equal or exceed the first threshold criterion, generating for display, in a user interface at the first user device, a first recommendation to modify the first static blockchain operation characteristic.

14. The one or more non-transitory, computer readable media of claim 13, wherein the instructions further cause operations comprising:
in response to determining that the first static blockchain operation characteristic equals or exceeds the first threshold criterion, determining a second static blockchain operation characteristic for the blockchain operation, wherein the second static blockchain operation characteristic is based on a second user input; and
determining a composite dynamic gas range for the blockchain operation, wherein the composite dynamic gas range comprises a composite lowerbound and a composite upperbound, and wherein the composite dynamic gas range is based on the first static blockchain operation characteristic, the first dynamic blockchain operation characteristic, and the second dynamic blockchain operation characteristic.

15. The one or more non-transitory, computer readable media of claim 14, wherein the instructions further cause operations comprising:
determining a first lowerbound for the blockchain operation based on the first dynamic blockchain operation characteristic;
determining a second lowerbound for the blockchain operation based on the second dynamic blockchain operation characteristic; and
determining the composite lowerbound of the composite dynamic gas range is based on summing the first lowerbound and the second lowerbound.

16. The one or more non-transitory, computer readable media of claim 14, wherein the instructions further cause operations comprising:
determining a first upperbound for the blockchain operation based on the first dynamic blockchain operation characteristic;
determining a second upperbound for the blockchain operation based on the second dynamic blockchain operation characteristic; and
determining the composite upperbound of the composite dynamic gas range is based on summing the first upperbound and the second upperbound.

17. The one or more non-transitory, computer readable media of claim 14, wherein the second user input indicates a priority designation for the blockchain operation, and wherein determining the composite dynamic gas range further comprises:
determining a third static blockchain operation characteristic for the blockchain operation based on the second static blockchain operation characteristic, wherein the third static blockchain operation characteristic comprises a first max priority fee;
determining a fourth static blockchain operation characteristic for the blockchain operation based on the second static blockchain operation characteristic, wherein the fourth static blockchain operation characteristic comprises a second max priority fee; and
determining a second threshold criterion based on a sum of the third static blockchain operation characteristic, the fourth static blockchain operation characteristic, and the first threshold criterion.

18. The one or more non-transitory, computer readable media of claim 17, wherein the instructions further cause operations comprising:
accessing a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations;
retrieving, from the user account, an account record;
comparing the account record to the second threshold criterion to determine whether the account record equals or exceeds the second threshold criterion; and
in response to determining that the account record does not equal or exceed the second threshold criterion, generating for display, in the user interface at the first user device, a second recommendation to modify one or more static blockchain operation characteristics of the blockchain operation.

19. The one or more non-transitory, computer readable media of claim 17, wherein the instructions further cause operations comprising:
in response to determining the third static blockchain operation characteristic, retrieving a historic max priority fee;
comparing the third static blockchain operation characteristic to the historic max priority fee to determine if the third static blockchain operation characteristic exceeds the historic max priority fee; and
in response to determining that the third static blockchain operation characteristic exceeds the historic max priority fee, generating for display, in the user interface at the first user device, a third recommendation to delay the blockchain operation.

20. The one or more non-transitory, computer readable media of claim 13, wherein the instructions further cause operations comprising:
receiving, at the first user device, a second user request confirming execution of the blockchain operation;
determining an actual gas fee for the blockchain operation; and
conducting the blockchain operation with the actual gas fee using the first cryptography-based, storage application.

21. The one or more non-transitory, computer readable media of claim 13, wherein the instructions further cause operations comprising:
accessing a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations;
retrieving, from the user account, a first partial private key and a user address;
querying user device for use of a second partial private key in performing the blockchain operation;
generating a first digital signature based on the first partial private key and the second partial private key; and
performing the blockchain operation based on the first digital signature and the user address.

22. The one or more non-transitory, computer readable media of claim 13, wherein the instructions further cause operations comprising:
retrieving first network congestion data and second network congestion data,
wherein determining the first dynamic blockchain operation characteristic comprises determining the first dynamic blockchain operation characteristic based on the first network congestion data, and
wherein determining the second dynamic blockchain operation characteristic comprises determining the second dynamic blockchain operation characteristic based on the second network congestion data.

23. The one or more non-transitory, computer readable media of claim 22, wherein the instructions further cause operations comprising:
in response to retrieving the first network congestion data, retrieving historic network congestion;
comparing the first network congestion data to the historic network congestion data to determine whether the first network congestion data exceeds the historic network congestion data; and
in response to determining that the first network congestion data exceeds the historic network congestion data, generating for display, in the user interface at the first user device, a recommendation to delay the blockchain operation.

24. A method comprising:
receiving, at a first user device, a first user request to execute a blockchain operation in a decentralized exchange using a first cryptography-based, storage application;
in response to receiving the first user request, determining a first static blockchain operation characteristic for the blockchain operation, wherein the first static blockchain operation characteristic is based on a first user input;
determining a first dynamic blockchain operation characteristic;
determining a second dynamic blockchain operation characteristic;
determining a first threshold criterion based on the first dynamic blockchain operation characteristic and the second dynamic blockchain operation characteristic;
comparing the first static blockchain operation characteristic to the first threshold criterion to determine whether the first static blockchain operation characteristic equals or exceeds the first threshold criterion; and
in response to determining that the first static blockchain operation characteristic does not equal or exceed the first threshold criterion, generating for display, in a user interface at the first user device, a first recommendation to modify the first static blockchain operation characteristic.

25. The method of claim 24, further comprising:
receiving a second user request comprising simultaneously performing a first action and a second action, wherein the first action approves an application to access the first cryptography-based, storage application, wherein the first cryptography-based, storage application corresponds to a first private key, and wherein the first private key is stored on the first user device, and wherein the second action causes execution of to confirm the blockchain operation.

26. The method of claim 24, further comprising:
in response to determining that the first static blockchain operation characteristic equals or exceeds the first threshold criterion, determining a second static blockchain operation characteristic for the blockchain operation, wherein the second static blockchain operation characteristic is based on a second user input; and
determining a composite dynamic gas range for the blockchain operation, wherein the composite dynamic gas range comprises a composite lowerbound and a composite upperbound, and wherein the composite dynamic gas range is based on the first static blockchain operation characteristic, the first dynamic blockchain operation characteristic, and the second dynamic blockchain operation characteristic.

27. The method of claim 26, further comprising:
determining a first lowerbound for the blockchain operation based on the first dynamic blockchain operation characteristic;
determining a second lowerbound for the blockchain operation based on the second dynamic blockchain operation characteristic; and
determining the composite lowerbound of the composite dynamic gas range is based on summing the first lowerbound and the second lowerbound.

28. The method of claim 26, wherein the second user input indicates a priority designation for the blockchain operation, and wherein determining the composite dynamic gas range further comprises:
determining a third static blockchain operation characteristic for the blockchain operation based on the second static blockchain operation characteristic, wherein the third static blockchain operation characteristic comprises a first max priority fee;
determining a fourth static blockchain operation characteristic for the blockchain operation based on the second static blockchain operation characteristic, wherein the fourth static blockchain operation characteristic comprises a second max priority fee; and
determining a second threshold criterion based on a sum of the third static blockchain operation characteristic, the fourth static blockchain operation characteristic, and the first threshold criterion.

29. The method of claim 28, further comprising:
accessing a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations;
retrieving, from the user account, an account record;
comparing the account record to the second threshold criterion to determine whether the account record equals or exceeds the second threshold criterion; and
in response to determining that the account record does not equal or exceed the second threshold criterion, generating for display, in the user interface at the first user device, a second recommendation to modify one or more static blockchain operation characteristics of the blockchain operation.

30. The method of claim 29, further comprising:
in response to determining the third static blockchain operation characteristic, retrieving a historic max priority fee;
comparing the third static blockchain operation characteristic to the historic max priority fee to determine if the third static blockchain operation characteristic exceeds the historic max priority fee; and
in response to determining that the third static blockchain operation characteristic exceeds the historic max priority fee, generating for display, in the user interface at the first user device, a third recommendation to delay the blockchain operation.

31. The method of claim 24, further comprising:
accessing a user account corresponding to a public key in response to receiving the first user request, wherein the first cryptography-based, storage application corresponds to the user account and is accessible to the first user device through a platform application, and wherein the first cryptography-based, storage application is used to perform a plurality of blockchain operations;
retrieving, from the user account, a first partial private key and a user address;
querying user device for use of a second partial private key in performing the blockchain operation;
generating a first digital signature based on the first partial private key and the second partial private key; and
performing the blockchain operation based on the first digital signature and the user address.
